(19) United States
(12) Patent Application Publication
(10) Pub. No.: US 2005/0289248 A1
(43) Pub. Date: Dec. 29, 2005

(54) Configurable printer and methods for configuring a printer

(75) Inventor: Stephen R. Payne, Cortland, NY (US)

Correspondence Address: Lipsitz & McAllister, LLC, 755 MAIN STREET, MONROE, CT, 06468, US

(73) Assignee: TransAct Technologies Incorporated, Wallingford, CT (US)

(21) Appl. No.: 10/875,395

(22) Filed: Jun. 24, 2004

(51) Int. Cl. G06F 13/10

(52) U.S. Cl. 710/8

(57) ABSTRACT

A configurable printer is provided which includes a first memory for storing multiple firmware application programs. Each of the firmware application programs enables respectively different printer functionalities. A switch mechanism, such as a DIP switch, is provided that has multiple settings for selecting a respective firmware application program from the multiple firmware application programs in the first memory. The printer also includes a second memory for storing a boot program. A processor is provided for executing the boot program upon startup of the printer. During execution, the boot program reads a current setting of the switch mechanism and executes a selected firmware application program corresponding to the current setting, thereby providing the desired printed functionality.

### BACKGROUND OF THE INVENTION

The present invention relates to the field of printing. More specifically, the present invention relates to a configurable printer and methods for configuring a printer using a hardware switch, such as a DIP (Dual Inline Package) switch for selecting different versions of printer firmware to run on power-up of the printer.

There are typically two prior art methods for providing printer configurability via one or more DIP switches. In the first method, the DIP switch positions are sensed or read when the firmware application program begins execution. When the switches are sensed or read the setting associated with each DIP switch setting is remembered by placing a corresponding value in memory for later use. When the printer needs the DIP switch setting information the “corresponding memory value” is read out of memory and the firmware program execution is directed based on the setting of the memory value.

In the second method, the DIP switch positions are sensed or read in “real-time”. When the device/printer needs the DIP switch setting information, the corresponding setting is sensed or read directly from the DIP switch settings and the firmware program execution is directed based on the setting of the switch.

The DIP switch settings may correspond to, for example, how many line feeds to do after a carriage return character is received, whether to do color or monochrome printing, whether to cut the document after printing, and the like.

The prior art technology is limited to the extent of how much the device's behavior or operation can be modified. The device still behaves in basically the same manner with minor or limited modification to the device's behavior or operation depending on the DIP switch setting.

With the advent of low cost memory components, an improved approach is possible that allows for more behavioral and operational configurability. It would be advantageous to provide DIP switch controlled configurability of a printer that improves the extent of the allowable modifications to the printer's behavior and operation. It would be further advantageous to improve the ease of implementing different behavior in a device that is configurable via DIP switches. It would also be advantageous if a change in one printer application is isolated from affecting the behavior/operation of another application (i.e. no unwanted, unexpected side effects).

The methods and apparatus of the present invention provide the foregoing and other advantages.

### SUMMARY OF THE INVENTION

The present invention relates to a configurable printer and methods for configuring a printer using a hardware switch, such as a DIP (Dual Inline Package) switch for selecting different versions of printer firmware to run on power-up of the printer.

In an example embodiment of the present invention, a configurable printer is provided. The printer includes a first memory for storing multiple firmware application programs. Each of the firmware application programs enables respectively different printer functionalities. A switch mechanism is provided that has multiple settings for selecting a respective firmware application program from the multiple firmware application programs in the first memory. The printer also includes a second memory for storing a boot program. A processor is provided for executing the boot program upon startup of the printer. During execution, the boot program reads a current setting of the switch mechanism and executes a selected firmware application program corresponding to the current setting.

For example, each of the multiple firmware applications may control at least one of: number of line feeds after receipt of a carriage return character; color or monochrome printing; cutting of a document after printing; command sets used for printer control; printer mechanism control algorithms; document presentation scheme; device resolution; printed text substitution; and the like.

The first memory and the second memory may comprise different memory locations in a single memory device. For example, the multiple firmware application programs and the boot program may be stored in separate locations in a Flash or ROM memory device.

The first memory and the second memory may each comprise separate non-volatile memory, for example separate Flash or ROM memory. The selected firmware application may be executed in one of volatile or non-volatile memory, for example in Flash, ROM, or RAM memory.

The switch mechanism may comprise a DIP switch or any other type of mechanical switching mechanism.

Corresponding methods for configuring a printer using DIP switch settings are also provided in accordance with the present invention.

### BRIEF DESCRIPTION OF THE DRAWINGS

The present invention will hereinafter be described in conjunction with the appended drawing figures, wherein like numerals denote like elements, and:

FIG. 1 shows a block diagram of an example embodiment of the invention;

FIG. 2 shows a flowchart of an example embodiment of the invention.

### DETAILED DESCRIPTION

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing an example embodiment of the invention. It should be understood that various changes may be made in the function and arrangement of elements without departing from the spirit and scope of the invention as set forth in the appended claims.

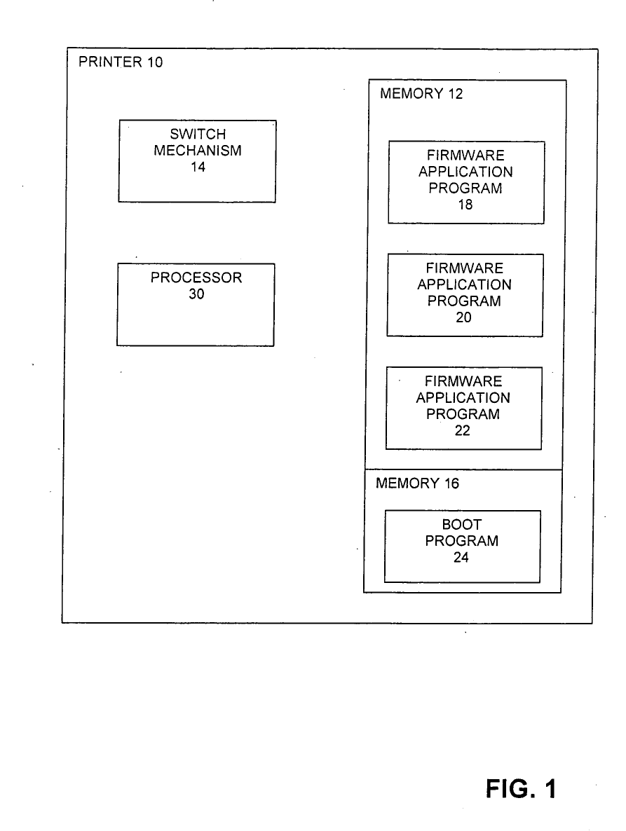

In an example embodiment of the present invention as shown in FIG. 1, a configurable printer 10 is provided. The printer includes a first memory 12 for storing multiple firmware application programs (e.g., firmware application programs 18, 20 and 22). Each of the firmware application programs 18, 20, and 22 enables respectively different printer functionalities. A switch mechanism 14 is provided which has multiple settings for selecting a respective firmware application program from the multiple firmware application programs 18, 20, 22 in the first memory 12. The printer 10 also includes a second memory 16 for storing a boot program 24. A processor 30 is provided for executing the boot program 24 upon startup of the printer 10. During execution, the boot program 24 reads a current setting of the switch mechanism 14 and executes a selected firmware application program corresponding to the current setting. In other words, the boot program 24 selects one of the firmware application programs 18, 20, or 22 to execute on startup based on the setting of the switch mechanism 14.

For example, each of the multiple firmware applications 18, 20, and 22 may control at least one of: number of line feeds after receipt of a carriage return character; color or monochrome printing; cutting of a document after printing; command sets used for printer control; printer mechanism control algorithms; document presentation scheme; device resolution; printed text substitution; and the like. Therefore, depending on the switch setting, the configuration of the printer 10 can easily be set to provide the desired functionality on startup. Further, the printer 10 can be easily re-configured by changing the switch setting and re-booting the printer 10.

The first memory 12 and the second memory 16 may comprise different memory locations in a single memory device. For example, the multiple firmware application programs 18, 20, and 22 and the boot program 24 may be stored in separate locations in a Flash or ROM memory device.

The first memory 12 and the second memory 14 may each comprise separate non-volatile memory, for example separate Flash or ROM memory.

The selected firmware application may be executed in one of volatile or non-volatile memory, for example in Flash, ROM, or RAM memory.

The switch mechanism 14 may comprise a DIP switch or any other type of mechanical switching mechanism.

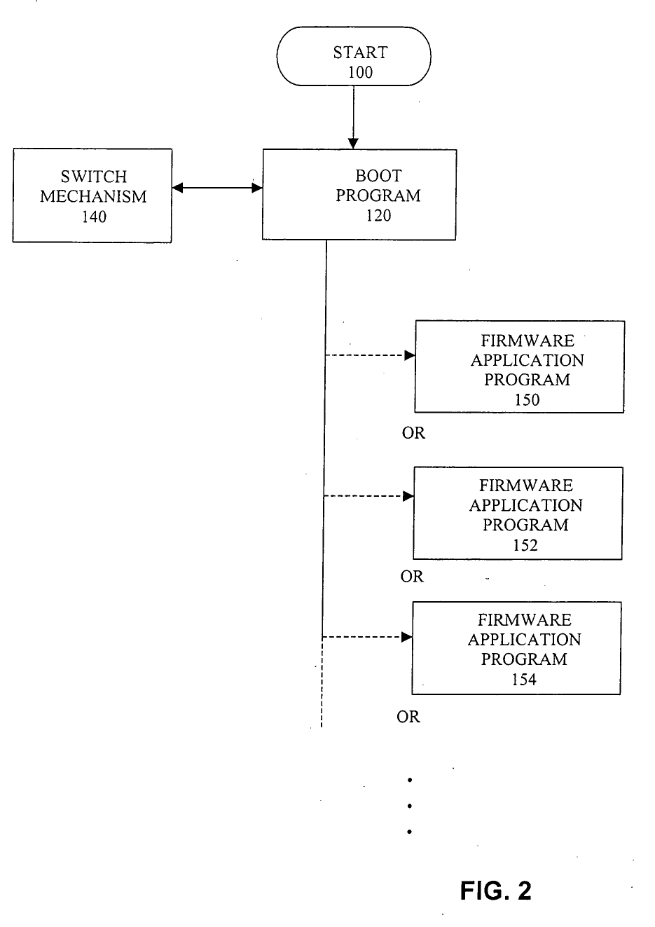

FIG. 2 shows a flowchart of an example embodiment of a method for configuring a printer in accordance with the present invention. Upon Startup 100, the processor reads the Boot Program 120. The Boot Program 120 reads the current setting of the Switch Mechanism 140, which points to a corresponding Firmware Application Program, such as Firmware Application Program 150, Firmware Application Program 152, or Firmware Application Program 154, each of which enables a different set of printer functionalities. The selected Firmware Application Program corresponding to the setting of the Switch Mechanism 140 will be then be executed by the processor to provide the desired printer configuration.

Although FIGS. 1 and 2 show only three different firmware application programs, those skilled in the art will appreciate that any number of firmware application programs may be stored in the printer 10, subject to the memory capacity of the printer.

Those skilled in the art will appreciate that, while the present invention is described herein in connection with the configuration of a printer, the present invention is equally applicable to the configuration of other devices, such as scanners, copiers, facsimile machines, and the like.

It should now be appreciated that the present invention provides advantageous methods and apparatus for easily configuring or re-configuring a device, such as a printer, using DIP switch settings for loading different versions of firmware.

Although the invention has been described in connection with various illustrated embodiments, numerous modifications and adaptations may be made thereto without departing from the spirit and scope of the invention as set forth in the claims.

1. A configurable printer, comprising:
a first memory for storing multiple firmware application programs, each of said firmware application programs enabling respectively different printer functionalities;
a switch mechanism having multiple settings for selecting a respective firmware application program from said multiple firmware application programs;
a second memory for storing a boot program; and
a processor for executing said boot program upon startup of said printer, wherein during execution, said boot program reads a current setting of said switch mechanism and executes a selected firmware application program corresponding to said current setting.

2. A configurable printer in accordance with claim 1, wherein:
said first memory and said second memory comprise different memory locations in a single memory device.

3. A configurable printer in accordance with claim 2, wherein:
said memory device comprises one of Flash or ROM memory.

4. A configurable printer in accordance with claim 1, wherein;
said first memory and said second memory each comprises non-volatile memory.

5. A configurable printer in accordance with claim 1, wherein:
said first memory and said second memory each comprises one of Flash or ROM memory.

6. A configurable printer in accordance with claim 1, wherein:
said selected firmware application is executed in one of volatile or non-volatile memory.

7. A configurable printer in accordance with claim 6, wherein:
said selected firmware application is executed in one of Flash, ROM, or RAM memory.

8. A configurable printer in accordance with claim 1, wherein:
said switch mechanism comprises a DIP switch.

9. A method for configuring a printer, comprising:
storing multiple firmware application programs, each of said firmware application programs enabling respectively different printer functionalities;
selecting a respective firmware application program from said multiple firmware application programs;
storing a boot program; and
executing said boot program upon startup of said printer, wherein during execution, said boot program executes said selected firmware application program.

10. A method printer in accordance with claim 9, wherein:
said multiple firmware application programs and said boot program are stored in different memory locations in a single memory device.

11. A method in accordance with claim 10, wherein:
said memory device comprises one of Flash or ROM memory.

12. A method in accordance with claim 9, wherein;
said multiple firmware application programs and said boot program are stored in non-volatile memory.

13. A method in accordance with claim 12, wherein:
said non-volatile memory one of Flash or ROM memory.

14. A method in accordance with claim 9, wherein:
said selected firmware application is executed in one of volatile or non-volatile memory.

15. A method in accordance with claim 14, wherein:
said selected firmware application is executed in one of Flash, ROM, or RAM memory.

16. A method in accordance with claim 9, wherein:
said selecting step is carried out using a switch mechanism having multiple settings, each setting corresponding to respective firmware application; and
said boot program reads a current setting of said switch mechanism and executes said selected firmware application corresponding to said current setting.

17. A method in accordance with claim 16, wherein:
said switch mechanism comprises a DIP switch.
